(19) United States
(12) Patent Application Publication
(10) Pub. No.: US 2014/0049735 A1
(43) Pub. Date: Feb. 20, 2014

(54) ARRAY SUBSTRATE, LIQUID CRYSTAL DISPLAY APPARATUS AND ALIGNMENT RUBBING METHOD

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Zailong Mo, Beijing (CN); Yuqing Yang, Beijing (CN); Tianlei Shi, Beijing (CN); Seung Yik Park, Beijing (CN)

(73) Assignees: CHENGDU BOE OPTOELECTRONICS TECHNOLOGY CO., LTD., Sichuan (CN); BOE TECHNOLOGY GROUP CO., LTD., Beijing (CN)

(21) Appl. No.: 13/805,715

(22) PCT Filed: Oct. 10, 2012
(86) PCT No.: PCT/CN2012/082723

§ 371 Date: Dec. 20, 2012

(30) Foreign Application Priority Data
Dec. 31, 2011 (CN) 201110460678.4

(51) Int. Cl. G02F 1/1337

(52) U.S. Cl. CPC G02F 1/133707; G02F 1/133784
USPC 349/106; 349/123; 349/124

(57) ABSTRACT

Embodiments of the present invention provide an array substrate, a liquid crystal display apparatus and an alignment rubbing method. The array substrate comprises a gate line, a data line, and a pixel unit defined by the gate line and the data line intersecting each other, as well as an alignment film formed on the array substrate. The pixel unit each comprises a thin film transistor, a first electrode, and a second electrode provided with slits; and a first non-zero preset angle is present between a slit-direction of the second electrode and a data-line-direction, a second non-zero preset angle is present between a rubbing direction of the alignment film and the slit-direction of the second electrode, and an angle between the rubbing direction of the alignment film and the data-line-direction is greater than the second non-zero preset angle.

### TECHNICAL FIELD

Embodiments of the present invention relate to an array substrate, a liquid crystal display apparatus and an alignment rubbing method.

### BACKGROUND

At present, liquid crystal displays (LCDs) with wide viewing angles mainly include those of an Advanced Super Dimension Switch (ADS) mode and an In-Plane Switching (IPS) mode. The ADS mode TFT-LCD forms a multi-dimensional electric field both a parallel electric field produced at edges of pixel electrodes on the same plane and a vertical electric field produced between a pixel electrode layer and a common electrode layer, so that liquid crystal molecules at all orientations, which are located directly above the electrodes and between the pixel electrodes in a liquid crystal cell, can be rotated and aligned, which enhances the work efficiency of planar-oriented liquid crystals and increases light transmittance. The Advanced-Super Dimensional Switching technology can improve the picture quality of TFT-LCDs and has advantages of high transmissivity, wide viewing angles, high opening ratio, low chromatic aberration, low response time, no push Mura, etc.

FIG. 1 shows a schematic illustration of an array substrate of an ADS mode LCD. On the base substrate, there are formed a plurality of pixel units arranged in an array form, and each pixel unit comprises a common electrode 01 (a plate-like electrode) and a pixel electrode 02 (a slit electrode comprising a plurality of slits) therein. The pixel electrode 02 is provided thereon with a plurality of slits 04 parallel to one another and parallel to a data line 03. After the formation of the pixel unit structure, a PI (polyimide) material is deposited on a surface thereof to form an alignment film, and alignment rubbing is required to be performed onto the alignment film to complete the manufacture of the array substrate. In FIG. 1, the data line 03 is taken as a reference line (in a longitudinal direction); in the coordinate system, the direction of the longitudinal coordinate Y is the same as the data-line-direction; the extending direction of the slits 04 of the pixel electrode 02 is the same as the data-line-direction; the forward direction 12 of the array substrate in the rubbing process is opposed to the Y-direction; and the rubbing direction 11 of the alignment film forms a certain angle with the slit-direction of the pixel electrode 02.

In the technique shown in FIG. 1, there is a comparatively small angle between the rubbing direction 11 of the alignment film and the opposite direction to the forward direction 12 of the array substrate, which results in a rather large relative velocity between the rubbing roller and the array substrate in the Y-direction during the relative movement of the rubbing roller and the array substrate, thus causes mutual damage between the rubbing roller and the array substrate, affects rubbing uniformity, and further leading to poor gradation for the prepared display device.

### SUMMARY

Embodiments of the present invention provide an array substrate, a liquid crystal display apparatus and an alignment rubbing method, for enhancing the rubbing uniformity.

In one aspect of the present invention, there is provided an array substrate, comprising a gate line, a data line, and a pixel unit defined by the gate line and the data line intersecting each other, as well as an alignment film formed on the array substrate; wherein the pixel unit each comprises a thin film transistor, a first electrode, and a second electrode provided with slits; and wherein a first non-zero preset angle is present between a slit-direction of the second electrode and a data-line-direction, a second non-zero preset angle is present between a rubbing direction of the alignment film and the slit-direction of the second electrode, and an angle between the rubbing direction of the alignment film and the data-line-direction is greater than the second non-zero preset angle.

In another aspect of the present invention, there is provided a liquid crystal display apparatus, comprising: an array substrate and a color filter substrate assembled together to form a cell, wherein the array substrate is an array substrate as described above, and a rubbing direction of an alignment film on the color filter substrate is opposed to a rubbing direction of an alignment film on the array substrate.

In further another aspect of the present invention, there is provided an alignment rubbing method, the method comprising:

setting a forward speed of an array substrate, as well as an axial direction and an angular velocity of a rubbing roller, wherein a linear direction, along which the forward speed of the array substrate is taken, is opposed to a data-line-direction on the array substrate, and a third non-zero preset angle is present between the axial direction of the rubbing roller and the data-line-direction on the array substrate, and a first non-zero preset angle is present between the data-line-direction and a slit-direction of a second electrode on the array substrate; and

making the array substrate moved in accordance with the set forward speed, and come into contact with the rubbing roller, in order to rub an alignment film on the array substrate, wherein a second non-zero preset angle is present between a rubbing direction of the alignment film and the slit-direction of the second electrode; the rubbing direction of the alignment film is perpendicular to the axial direction of the rubbing roller, and an angle between the rubbing direction of the alignment film and the data-line-direction is greater than the second non-zero preset angle.

In the array substrate, the liquid crystal display apparatus and the alignment rubbing method provided by the embodiments of the present invention, on one hand, by setting a second non-zero preset angle between a rubbing direction of an alignment film and a slit-direction of a second electrode, the needs of a high aperture ratio and high transmittance are met, and thus the normal display of the liquid crystal display is ensured; on the other hand, by setting a first non-zero preset angle between the slit-direction of the second electrode and a data-line-direction, and letting the angle between the rubbing direction of the alignment film and the data-line-direction greater than the second non-zero preset angle, the relative velocity between the rubbing roller and the array substrate in their relative movement in the data-line-direction is reduced, so that the mutual damage between the rubbing roller and the substrate is reduced, thereby enhancing the rubbing uniformity.

### BRIEF DESCRIPTION OF THE DRAWINGS

In order to clearly illustrate the technical solutions of the embodiments of the invention, the drawings of the embodiments will be briefly described in the following; it is obvious that the described drawings are only related to some embodiments of the invention and thus are not limitative of the invention.

FIG. 1 is a top view of an array substrate in the prior art;

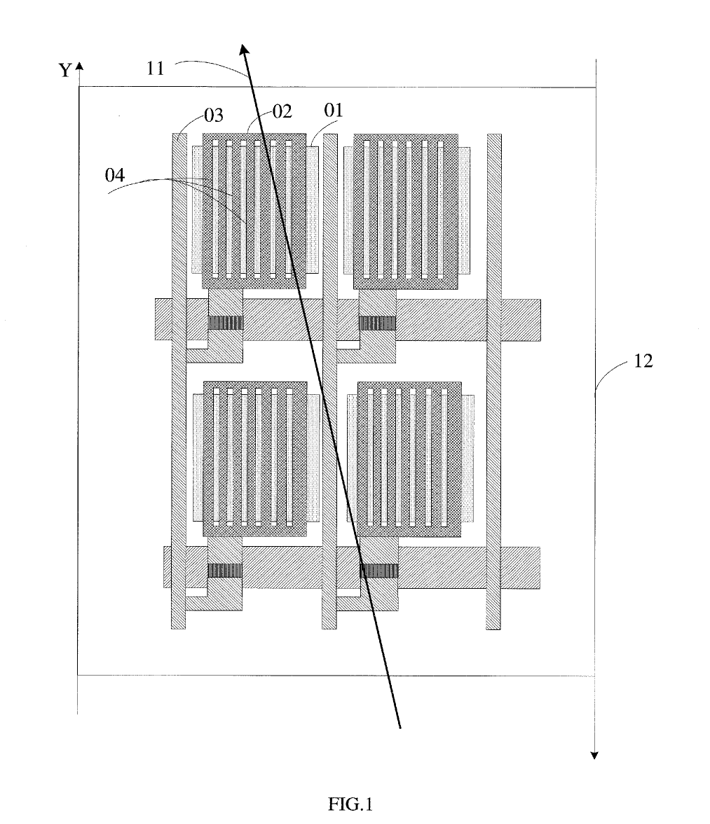

FIG. 2 is a top view of an array substrate provided by an embodiment of the present invention;

FIG. 3 is a schematic illustration of a relationship among a slit-direction, a rubbing direction, and a data-line-direction in the array substrate shown in FIG. 2;

FIG. 4 is a top view of another array substrate provided by an embodiment of the present invention;

FIG. 5 is a schematic illustration of an alignment rubbing method provided by an embodiment of the present invention; and

FIG. 6 is a schematic illustration of a relationship among a slit-direction, a rubbing direction, and a data-line-direction in the alignment rubbing method shown in FIG. 5.

### REFERENCE NUMERALS

01—Common electrode; 02—Pixel electrode; 03—Data line; 04—Slit; 05—Gate line; 06—Thin film transistor; 11—Rubbing direction; 12—Forward direction of a substrate; 13—Slit-direction; 14—Axial direction of a rubbing roller.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

An array substrate according to an embodiment of the present invention comprises a plurality of gate lines and a plurality of data lines, and these gate lines and data lines intersect one another and thus define pixel units arranged in a matrix, each pixel unit comprising a thin film transistor as a switching element and a pixel electrode for controlling the alignment of liquid crystal. In the following description, it is mainly directed to a single or a plurality of pixel units, but other pixel units may be formed in the same way.

### First Embodiment

In all embodiments of the present invention, a data line is taken as a reference line, so that the direction of a longitudinal coordinate Y in a coordinate system is in accordance with the data-line-direction.

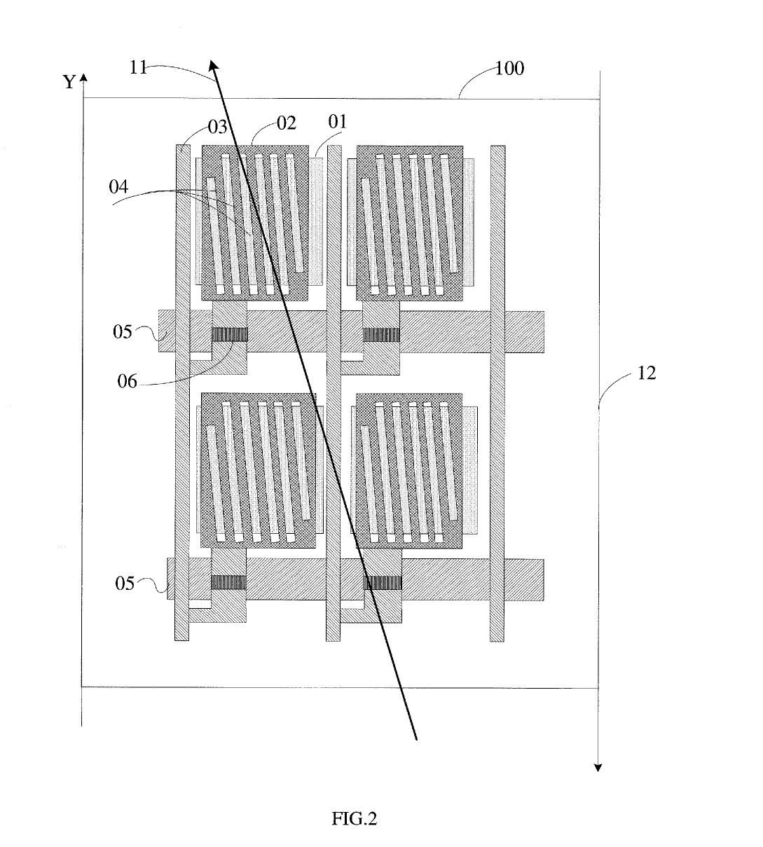

As shown in FIG. 2, an embodiment of the present invention provides an array substrate 100, comprising: gate lines 05, data lines 03, and a plurality of pixel units defined by the gate lines 05 and the data lines 03 intersecting one another. On a surface of the array structure of the array substrate, there is formed an alignment film. The alignment film is formed of, for example, a PI (polyimide) material.

Each of the pixel units comprises a thin film transistor 06, a plate-like first electrode, and a second electrode provided with slits 04. A first non-zero preset angle θ1 is present between the slit-direction 13 (i.e., the extending direction of the slits) of the second electrode and the data-line-direction Y, and a second non-zero preset angle θ2 is present between a rubbing direction 11 of the alignment film and the slit-direction 13 of the second electrode, moreover, the angle between the rubbing direction 11 of the alignment film and the data-line-direction Y is greater than the second non-zero preset angle θ2.

In this embodiment, the first electrode is formed from a first transparent electric-conductive layer in a pixel unit of the array substrate 100, and for example, it may typically be a first indium-tin oxide (ITO) layer; the second electrode is formed from a second transparent electric-conductive layer in the pixel unit of the array substrate 100, and for example, it may typically be a second ITO layer. In this embodiment of the present invention, since a multi-dimensional electric field is generated by the first and second electrodes of the pixel unit of the array substrate 100 to drive the liquid crystal, the second electrode is usually formed into a patterned electrode, and the pattern is typically elongated slits, and these slits may be enclosed on periphery or open at one end. In addition, of the first and second electrodes, the electrode that is connected with a drain of the thin film transistor 06 in the pixel unit is a pixel electrode, and the other is for example a common electrode connected with a common electrode line.

In one example of the embodiment, the first electrode is electrically connected with a common electrode line of the array substrate; the second electrode is electrically connected with a drain of the thin film transistor 06; as shown in FIG. 2, that is, in this example, the second electrode is a pixel electrode 02, and the first electrode is a common electrode 01. The pixel electrode 02 is provided thereon with a plurality of slits 04; the common electrode 01 has no slit provided thereon and is shaped into a plate. These slits 04, for example, are parallel to each other and enclosed on periphery. The slits 04 extend obliquely with respect to the gate line 05 (or the data lines 03), and hereafter the extending direction of the slits 04 is referred to as the slit-direction 13.

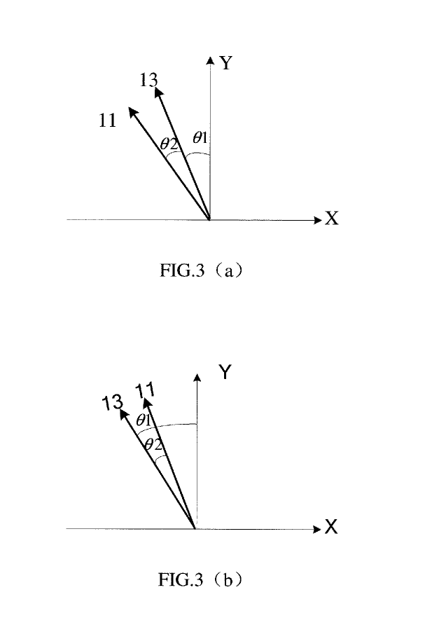

After the preparation of an array structure, comprising driving elements, of the array substrate, an alignment film is coated on the array structure, and then the alignment film is subject to an alignment rubbing operation. During the alignment film rubbing, as shown in FIG. 3 (a), when an angle formed between the rubbing direction 11 and the Y-direction is greater than an angle formed between the slit-direction 13 of the second electrode and the Y-direction, a first non-zero preset angle θ1 is present between the slit-direction 13 of the second electrode and the data-line-direction Y, and a second non-zero preset angle θ2 is present between the rubbing direction 11 of the alignment film and the slit-direction 13 of the second electrode. Thus it can be seen that the value of the angle between the rubbing direction 11 of the alignment film and the data-line-direction Y is the sum of the value of the first non-zero preset angle θ1 and the value of the second non-zero preset angle θ2. This makes the relative velocity between the rubbing roller and the array substrate in their relative movement in the Y-direction reduced, so that the mutual damage between the rubbing roller and the substrate is reduced, thereby enhancing the rubbing uniformity. Preferably, the first non-zero preset angle θ1 is in a range of 20-30 degrees, such an angle is easy to be achieved in the manufacturing process and makes the mutual damage between the rubbing roller and the substrate reduced, thereby enhancing the rubbing uniformity; preferably, the second non-zero preset angle θ2 is in a range of 5-9 degrees, and such an angle meets the needs of a high aperture ratio and high transmittance, and therefore the normal display of the liquid crystal display is ensured.

As shown in FIG. 3(b), when an angle formed between the rubbing direction 11 and the Y-direction is less than an angle formed between the slit-direction 13 of the second electrode and the Y-direction, a first non-zero preset angle θ1 is present between the slit-direction 13 of the second electrode and the data-line-direction Y, and a second non-zero preset angle θ2 is present between the rubbing direction 11 of the alignment film and the slit-direction 13 of the second electrode. Thus it can be seen that, the value of the angle between the rubbing direction 11 of the alignment film and the data-line-direction is the difference of the value of the first non-zero preset angle θ1 minus the value of the second non-zero preset angle θ2. On condition that the angle between the rubbing direction 11 of the alignment film and the data-line-direction Y is ensured to be greater than the second non-zero preset angle θ2, the relative velocity between the rubbing roller and the array substrate in their relative movement in the Y-direction can be reduced likewise, so that the mutual damage between the rubbing roller and the substrate is reduced, thereby enhancing the rubbing uniformity. Preferably, the first non-zero preset angle θ1 is in a range of 20-30 degrees, such an angle is easy to be achieved in the manufacturing process, and makes the mutual damage between the rubbing roller and the substrate reduced, thereby enhancing the rubbing uniformity; preferably, the second non-zero preset angle θ2 is in a range of 5-9 degrees, and such an angle meets the needs of a high aperture ratio and high transmittance, and therefore the normal display of the liquid crystal display is ensured.

This embodiment provides an array substrate, which, on one hand, is provided with a second non-zero preset angle between a rubbing direction of an alignment film and a slit-direction of a second electrode so as to meet the needs of a high aperture ratio and high transmittance, thus ensuring the normal display of the liquid crystal display, and on the other hand, is provided with a first non-zero preset angle between the slit-direction of the second electrode and a data-line-direction, making the angle between the rubbing direction of the alignment film and the data-line-direction greater than the second non-zero preset angle, thus reducing the relative velocity between the rubbing roller and the array substrate in their relative movement in the Y-direction, so that the mutual damage between the rubbing roller and the substrate is reduced, thereby enhancing the rubbing uniformity.

### Second Embodiment

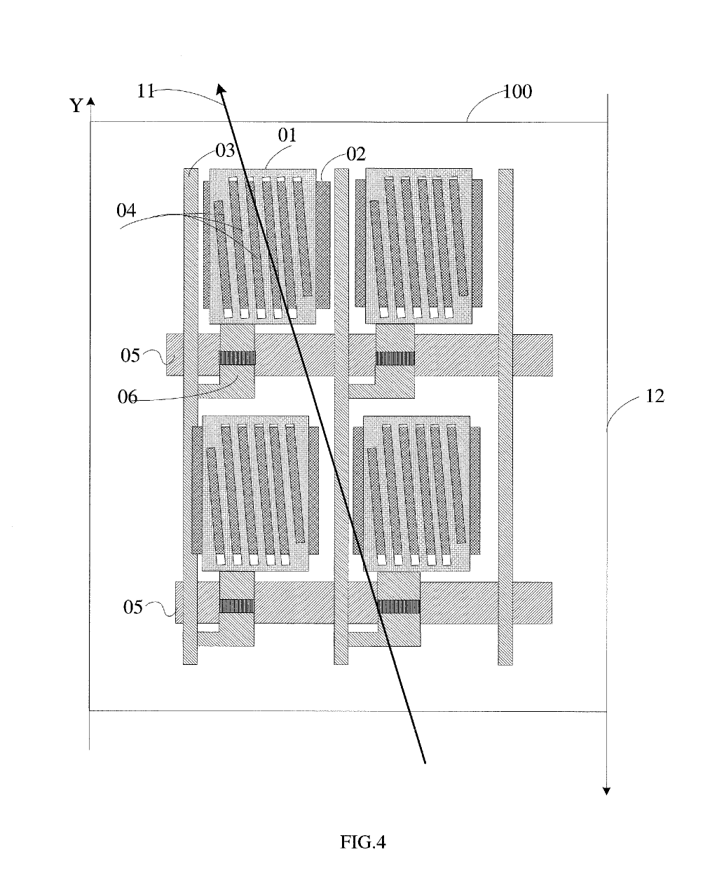

As shown in FIG. 4, this embodiment provides an array substrate 100, comprising: gate lines 05, data lines 03, and a plurality of pixel units defined by the gate lines 05 and the data lines 03 intersecting one another. On a surface of the array structure of the array substrate, there is an alignment film. The alignment film is formed of, for example, a PI (polyimide) material.

Each of the pixel units comprises a thin film transistor, a plate-like first electrode, and a second electrode provided with slits 04; a first non-zero preset angle θ1 is present between the slit-direction 13 (i.e., the extending direction of the slits) of the second electrode and the data-line-direction, and a second non-zero preset angle θ2 is present between a rubbing direction 11 of the alignment film and the slit-direction of the second electrode; moreover, the angle between the rubbing direction 11 of the alignment film and the data-line-direction Y is greater than the second non-zero preset angle θ2.

In this embodiment, the first electrode is formed from a first transparent electric-conductive layer formed in a pixel unit of the array substrate 100, for example, it may typically be a first indium-tin oxide (ITO) layer; the second electrode is formed from a second transparent electric-conductive layer formed in the pixel unit of the array substrate 100, for example, it may typically be a second ITO layer. In this embodiment of the present invention, since a multi-dimensional electric field is generated by the first and second electrodes of the pixel unit of the array substrate 100 to drive the liquid crystal, the second electrode is usually formed into a patterned electrode, and the pattern is typically elongated slits, and these slits may be enclosed on periphery or open at one end. In addition, in the first and second electrodes, the electrode that is connected with a drain of the thin film transistor 06 in the pixel unit is a pixel electrode, and the other is for example a common electrode connected with a common electrode line.

In one example of the embodiment, the first electrode is electrically connected with a drain of the thin film transistor 06; the second electrode is electrically connected with a common electrode line of the array substrate; as shown in FIG. 4, that is, in this example, the second electrode is a common electrode 01, and the first electrode is a pixel electrode 02. The common electrode 01 is provided thereon with a plurality of slits 04, while the pixel electrode 02 has no slit provided thereon and is shaped into a plate. These slits 04, for example, are parallel to each other, and enclosed on periphery. The slit 04 extends obliquely with respect to the gate line 05 (or the data lines 03), and hereafter the extending direction of the slits 04 is referred to as the slit-direction 13.

After the preparation of an array structure, comprising driving elements, of the array substrate, an alignment film is coated on the array structure, and then the alignment film is subject to an alignment rubbing operation. During the alignment film rubbing, as shown in FIG. 3 (a), when an angle formed between the rubbing direction 11 and the Y-direction is greater than an angle formed between the slit-direction 13 of the second electrode and the Y-direction, a first non-zero preset angle θ1 is present between the slit-direction 13 of the second electrode and the data-line-direction Y, and a second non-zero preset angle θ2 is present between the rubbing direction 11 of the alignment film and the slit-direction 13 of the second electrode. Thus it can be seen that the value of the angle between the rubbing direction 11 of the alignment film and the data-line-direction Y is the sum of the value of the first non-zero preset angle θ1 and the value of the second non-zero preset angle θ2. This makes the relative velocity between the rubbing roller and the array substrate in their relative movement in the Y-direction reduced. Thus the mutual damage between the rubbing roller and the substrate is reduced, thereby enhancing the rubbing uniformity. Preferably, the first non-zero preset angle θ1 is in a range of 20-30 degrees, such an angle is easy to be achieved in the manufacturing process, and makes the mutual damage between the rubbing roller and the substrate reduced, thereby enhancing the rubbing uniformity; preferably, the second non-zero preset angle θ2 is in a range of 5-9 degrees, and such an angle meets the needs of a high aperture ratio and high transmittance, and therefore the normal display of the liquid crystal display is ensured.

As shown in FIG. 3(b), when an angle formed between the rubbing direction 11 and the Y-direction is less than an angle formed between the slit-direction 13 of the second electrode and the Y-direction, a first non-zero preset angle θ1 is present between the slit-direction 13 of the second electrode and the data-line-direction Y, and a second non-zero preset angle θ2 is present between the rubbing direction 11 of the alignment film and the slit-direction 13 of the second electrode. Thus it can be seen that, the value of the angle between the rubbing direction 11 of the alignment film and the data-line-direction is the difference of the value of the first non-zero preset angle θ1 minus the value of the second non-zero preset angle θ2. On condition that the angle between the rubbing direction 11 of the alignment film and the data-line-direction Y is ensured to be greater than the second non-zero preset angle θ2, this makes the relative velocity between the rubbing roller and the array substrate in their relative movement in the Y-direction reduced likewise, so that the mutual damage between the rubbing roller and the substrate is reduced, thereby enhancing the rubbing uniformity. Preferably, the first non-zero preset angle θ1 is in a range of 20-30 degrees, such an angle is easy to be achieved in the manufacturing process, and makes the mutual damage between the rubbing roller and the substrate reduced, thereby enhancing the rubbing uniformity; preferably, the second non-zero preset angle θ2 is in a range of 5-9 degrees, and such an angle meets the needs of a high aperture ratio and high transmittance, and therefore the normal display of the liquid crystal display is ensured.

This embodiment provides an array substrate, which, on one hand, is provided with a second non-zero preset angle between a rubbing direction of an alignment film and a slit-direction of a second electrode so as to meet the needs of a high aperture ratio and high transmittance, thus ensuring the normal display of the liquid crystal display, and on the other hand, is provided with a first non-zero preset angle between the slit-direction of the second electrode and a data-line-direction, making the angle between the rubbing direction of the alignment film and the data-line-direction greater than the second non-zero preset angle, thus reducing the relative velocity between the rubbing roller and the array substrate in their relative movement in the Y-direction, so that the mutual damage between the rubbing roller and the substrate is reduced, thereby enhancing the rubbing uniformity.

### Third Embodiment

This embodiment provides an alignment rubbing method used for an alignment film of an array substrate, the method comprising the steps as follows.

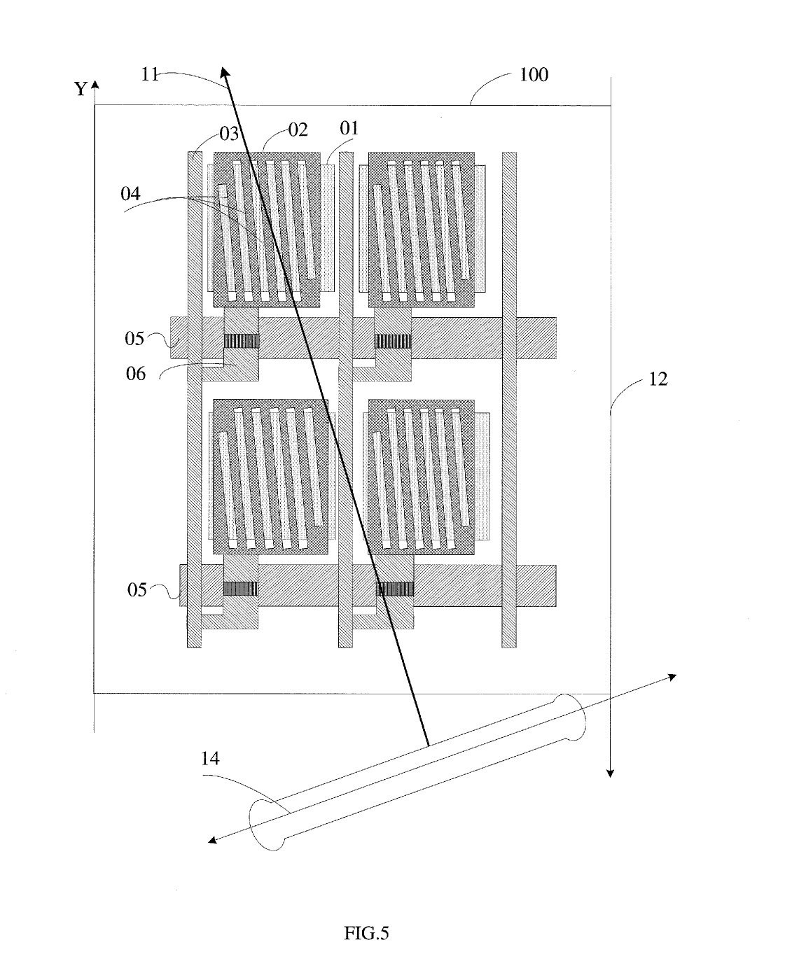

A schematic illustration of the operation of the rubbing method is shown as FIG. 5. First is to set a forward speed of an array substrate, as well as both an axial direction 14 and a rotating angular velocity of a rubbing roller; the linear direction 12, along which the forward speed of the array substrate is taken, is opposed to a data-line-direction 03 on the array substrate. A third non-zero preset angle θ3 is present between the axial direction 14 of the rubbing roller and the data-line-direction 03 on the array substrate, and a first non-zero preset angle θ1 is present between the data-line-direction Y and a slit-direction 13 of a second electrode on the array substrate.

The array substrate is moved in accordance with the set forward speed, and come into contact with the rubbing roller, and thus the rubbing roller rubs an alignment film formed on the surface of the array structure of the array substrate, so that a second non-zero preset angle θ2 is present between the rubbing direction 11 of the alignment film and the slit-direction 13 of the second electrode; the rubbing direction 11 of the alignment film is perpendicular to the axial direction 14 of the rubbing roller, and moreover the angle between the rubbing direction 11 of the alignment film and the data-line-direction is greater than the second non-zero preset angle.

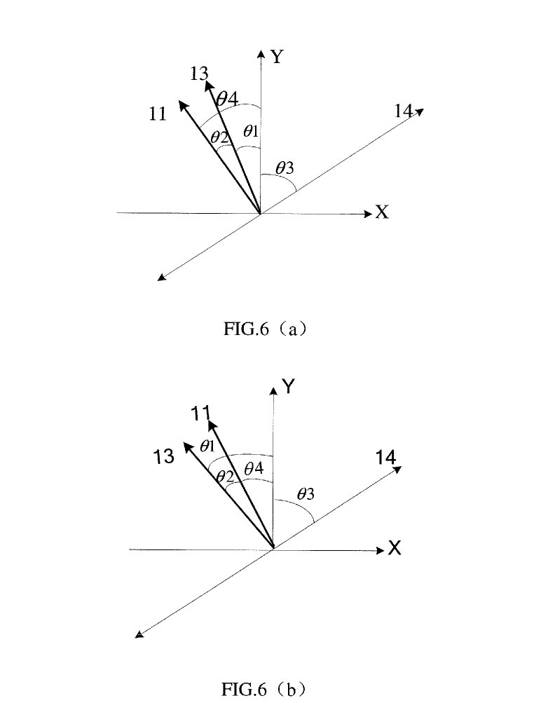

As shown in FIG. 6(a), when an angle formed between the rubbing direction 11 and the Y-direction is greater than an angle formed between the slit-direction 13 of the second electrode and the Y-direction, since the axial direction 14 of the rubbing roller is perpendicular to the rubbing direction 11 of the alignment film, the value of the complementary angle θ4 of the third non-zero preset angle θ3 is the sum of the value of the first non-zero preset angle θ1 and the value of the second non-zero preset angle θ2. The value of the complementary angle of the third non-zero preset angle θ3 is exactly the value of the angle between the rubbing direction of the alignment film and the data-line-direction. Thus it can be seen that, the value of the angle between the rubbing direction of the alignment film and the data-line-direction is the sum of the value of the first non-zero preset angle θ1 and the value of the second non-zero preset angle θ2.

As shown in FIG. 6(b), when an angle formed between the rubbing direction 11 and the Y-direction is less than an angle formed between the slit-direction 13 of the second electrode and the Y-direction, since the axial direction 14 of the rubbing roller is perpendicular to the rubbing direction 11 of the alignment film, the value of the complementary angle θ4 of the third non-zero preset angle θ3 is the difference of the value of the first non-zero preset angle θ1 minus the value of the second non-zero preset angle θ2. The value of the complementary angle of the third non-zero preset angle is exactly the value of the angle between the rubbing direction of the alignment film and the data-line-direction. Thus it can be seen that, the value of the angle between the rubbing direction of the alignment film and the data-line-direction is the difference of the value of the first non-zero preset angle θ1 minus the value of the second non-zero preset angle θ2.

The alignment film, for example, formed of a PI (polyimide) material, is coated on a surface of the array structure of the array substrate.

This embodiment provides an alignment rubbing method, comprising setting a forward speed of an array substrate and an axial direction of a rubbing roller, letting the rubbing direction of the alignment film perpendicular to the axial direction of the rubbing roller, and the method, on one hand by setting a second non-zero preset angle to be present between a rubbing direction of an alignment film and a slit-direction of a second electrode, meets the needs of a high aperture ratio and high transmittance, thus ensuring the normal display of a liquid crystal display, and on the other hand, by setting a first non-zero preset angle to be present between the slit-direction of the second electrode and a data-line-direction, and letting the angle between the rubbing direction of the alignment film and the data-line-direction greater than the second non-zero preset angle, so that the relative velocity between the rubbing roller and the array substrate is reduced in their relative movement in the Y-direction, reduces the mutual damage between the rubbing roller and the substrate, thereby enhancing the rubbing uniformity.

An embodiment of the present invention further provides a liquid crystal display apparatus, comprising an array substrate and a color filter substrate, which are disposed opposite to each other, and the array substrate is any one of the array substrates described in the above embodiments. A rubbing direction of an alignment film on the color filter substrate is opposed to a rubbing direction of an alignment film on the array substrate. Liquid crystal is filled in the space formed between the array substrate and the color film substrate, and the alignment films both on the array substrate and on the color filter substrate are used for initial alignment of the liquid crystal molecules in contact with them, by means of micro grooves and the like formed by a rubbing operation.

The array substrate comprises gate lines, data lines, and pixel units defined by the gate lines and the data lines intersecting one another. On the array substrate, there is formed an alignment film. The pixel unit comprises a thin film transistor, a first electrode, and a second electrode provided with slits; a second non-zero preset angle is present between a rubbing direction of the alignment film and the slit-direction of the second electrode, thus the needs of a high aperture ratio and high transmittance are met, and therefore the normal display of the liquid crystal display is ensured; a first non-zero preset angle is present between the slit-direction of the second electrode and the data-line-direction, and moreover, the angle between the rubbing direction of the alignment film and the data-line-direction is greater than the second non-zero preset angle, thus the relative velocity between the rubbing roller and the array substrate in their relative movement in the data-line-direction is reduced, so that the mutual damage between the rubbing roller and the substrate is reduced, thereby enhancing the rubbing uniformity.

In the disclosed technical scope of the present invention, variations or modifications, which can be easily conceived by any artisan familiar with ordinary technology in the art, should be encompassed by the protection scope of the present invention. Therefore, the protection scope of the present invention should be defined by the scope of the claims.

1. An array substrate, comprising a gate line, a data line, and a pixel unit defined by the gate line and the data line intersecting each other, as well as an alignment film formed on the array substrate;
wherein the pixel unit each comprises a thin film transistor, a first electrode, and a second electrode provided with slits; and
wherein a first non-zero preset angle is present between a slit-direction of the second electrode and a data-line-direction, a second non-zero preset angle is present between a rubbing direction of the alignment film and the slit-direction of the second electrode, and an angle between the rubbing direction of the alignment film and the data-line-direction is greater than the second non-zero preset angle.

2. The array substrate according to claim 1, wherein a value of an angle between the rubbing direction of the alignment film and the data-line-direction is the sum of a value of the first non-zero preset angle and a value of the second non-zero preset angle, or a difference of the value of the first non-zero preset angle minus the value of the second non-zero preset angle.

3. The array substrate according to claim 1, wherein the first electrode is electrically connected with a common electrode line of the array substrate; and the second electrode is electrically connected with a drain of the thin film transistor.

4. The array substrate according to claim 1, wherein the first electrode is electrically connected with a drain of the thin film transistor; and the second electrode is electrically connected with a common electrode line of the array substrate.

5. The array substrate according to claim 1, wherein the first non-zero preset angle is in a range of 20-30 degrees.

6. The array substrate according to claim 1, wherein the second non-zero preset angle is in a range of 5-9 degrees.

7. A liquid crystal display apparatus, comprising: an array substrate and a color filter substrate assembled together to form a cell, wherein the array substrate is in accordance with claim 1, and a rubbing direction of an alignment film on the color filter substrate is opposed to a rubbing direction of an alignment film on the array substrate.

8. A method for alignment rubbing of an array substrate, comprising:
setting a forward speed of an array substrate, as well as an axial direction and an angular velocity of a rubbing roller, wherein a linear direction, along which the forward speed of the array substrate is taken, is opposed to a data-line-direction on the array substrate, and a third non-zero preset angle is present between the axial direction of the rubbing roller and the data-line-direction on the array substrate, and a first non-zero preset angle is present between the data-line-direction and a slit-direction of a second electrode on the array substrate; and
making the array substrate moved in accordance with the set forward speed, and come into contact with the rubbing roller, in order to rub an alignment film on the array substrate, wherein a second non-zero preset angle is present between a rubbing direction of the alignment film and the slit-direction of the second electrode; the rubbing direction of the alignment film is perpendicular to the axial direction of the rubbing roller, and an angle between the rubbing direction of the alignment film and the data-line-direction is greater than the second non-zero preset angle.

9. The method according to claim 8, wherein
a value of a complementary angle of the third non-zero preset angle is a sum of a value of the first non-zero preset angle and a value of the second non-zero preset angle; or
a value of a complementary angle of the third non-zero preset angle is a difference of a value of the first non-zero preset angle minus a value of the second non-zero preset angle.

10. The array substrate according to claim 2, wherein the first electrode is electrically connected with a common electrode line of the array substrate; and the second electrode is electrically connected with a drain of the thin film transistor.

11. The array substrate according to claim 2, wherein the first electrode is electrically connected with a drain of the thin film transistor; and the second electrode is electrically connected with a common electrode line of the array substrate.

12. The array substrate according to claim 2, wherein the first non-zero preset angle is in a range of 20-30 degrees.

13. The array substrate according to claim 2, wherein the second non-zero preset angle is in a range of 5-9 degrees.
